(19) United States
(12) Patent Application Publication
(10) Pub. No.: US 2013/0115489 A1
(43) Pub. Date: May 9, 2013

(54) BATTERY HAVING TEMPERATURE REGULATION

(71) Applicants: Axel Krause, Nesslau (CH); Andrea Meier, Sennwald (CH)

(72) Inventors: Axel Krause, Nesslau (CH); Andrea Meier, Sennwald (CH)

(73) Assignee: BRUSA ELEKTRONIK AG, Sennwald (CH)

(21) Appl. No.: 13/511,141

(22) PCT Filed: Nov. 23, 2010
(86) PCT No.: PCT/IB10/55367

§ 371 Date: Jul. 11, 2012

Related U.S. Application Data
(60) Provisional application No. 61/267,000, filed on Dec. 4, 2009.

(30) Foreign Application Priority Data
Dec. 4, 2009 (CH) 01862/09

(51) Int. Cl. H01M 10/50

(52) U.S. Cl. CPC H01M 10/50
USPC 429/71

(57) ABSTRACT

A battery (1a . . . 1e) having a housing (2) and a plurality of galvanic cells (3) arranged in the housing (2) is provided. In addition, a fan (5a . . . 5c) is arranged in the housing (2) to create a fluid flow circulating inside the housing (2). According to the invention, a heat exchanger (6a . . . 6e) having a forward flow (7) and a return flow (8) for a heat transfer medium, which lead out of the housing (2) is arranged in the flow path (A) of the fluid flow.

This application is a 35 U.S.C. 371 national-phase entry of PCT International application no. PCT/IB2010/055367 filed on Nov. 23, 2010 and also claims benefit of foreign priority to Swiss national application no. CH-1862/09 filed on Dec. 4, 2009, and also claims priority as a non-provisional of U.S. provisional application Ser. No. 61/267,000 filed on Dec. 4, 2009; both Swiss national application no. CH-1862/09 and U.S. provisional application Ser. No. 61/267,000 are incorporated herein by reference in their entireties for all intents and purposes, as if identically set forth in full herein.

The invention relates to a battery having a housing, a plurality of galvanic cells arranged in the housing and a fan arranged in the housing for generating a fluid stream circulating inside the housing, in particular a gas or air stream.

Electric and electronic devices which can be operated independently of an electric power grid are increasingly in use today. Powerful devices and the desire for a long operating time demand powerful batteries, which should of course be small and lightweight while nevertheless having a high energy capacity. These requirements apply to electric vehicles in particular. A future without battery-powered electric vehicles can no longer be imagined. The introduction of large numbers of electric vehicles into street traffic thus appears to be imminent, despite the fact that their existence was for a long time limited to niche applications, for example, as forklifts and mining cars.

An important point in achieving optimum efficiency from a battery is the regulation of its temperature. A galvanic cell can deliver optimal power only in a certain temperature range. The power drops if it is too cold or too hot. In addition, excessive heating is also associated with the risk of damage or even destruction of the cell. In the extreme case, a cell may even explode or, if its excess temperature is transferred to other cells in a chain reaction, the entire battery may explode. Because of the high power content, batteries of electric vehicles therefore constitute a substantial potential risk. A number of approaches for cooling or heating batteries are already known from the state of the art.

For example, JP 06283214 A describes a heating system for a sodium-sulfur battery. Air is heated with a heating system and distributed with a fan inside a closed battery housing.

DE 10 2005 016 042 A1 also discloses a cooling system with the aid of a fan for a lithium-ion battery, in which the cells are arranged at a distance from one another in a housing. The housing also has air inlet and outlet openings for this purpose.

In addition, US 2008/0299449 A1 describes an arrangement of plate-shaped lithium cells arranged a distance apart from one another with the aid of a frame. A fan blows air through the interspaces.

Finally, US 2008/0003491 A1 discloses a cooling system for a battery, in which a heat exchanger is used to transport thermal energy out of the battery.

In the past, there have been various attempts to cool or heat batteries. However, according to the state of the art, the known devices cover only partial aspects of efficient temperature regulation of a battery. For example, the approach disclosed in JP 06283214 A is suitable only for heating cells. However, cooling, which is indispensable to reduce the risk of cell damage or cell destruction, is not provided.

DE 10 2005 016 042 A1 and US 2008/0299449 A1 disclose approaches in which air is drawn into the battery housing through an air inlet opening and is blown out again through an outlet opening. The disadvantage here is that the bulky air guidance channels ducts are a problem in installation of a battery because of the limited space available in a motor vehicle. In addition, these batteries are usually positioned near the floor for operation of a motor vehicle, which is why soil and moisture can easily be drawn into the battery. Finally, gases escaping from the cells are blown to the outside, which involves severe pollution of the environment or constitutes a safety risk in an enclosed space.

Finally, the battery presented in US 2008/0003491 A1 has the disadvantage that the cells are cooled very irregularly because the cooling medium cools the cells only at a few locations inside the battery. This results in an uneven temperature distribution inside the battery, which is why local overheating of the cells cannot be ruled out with sufficient reliability. In addition, the device presented in US 2008/0003491 A1 is provided only for cooling the battery but not for heating it.

The object of the present invention is to provide an improved battery and/or an improved system for regulating the temperature of the battery.

According to the invention, this object is achieved by a battery of the type defined in the introduction, in which a heat exchanger having a forward flow and a return flow for a heat transfer medium leading out of the housing are arranged in the flow path of the fluid flow.

The present invention overcomes several disadvantages of the state of the art at the same time. First, the cells can be heated as well as cooled. Heating plays an important role, especially in operation of the cells in the cold season. The importance of cooling of the cells in minimizing a safety risk has already been explained in detail. Second, no bulky inlet and outlet channels are needed, so that installation in a motor vehicle is facilitated. Openings in the housing, if they are present at all, can be positioned relatively easily, so there is no risk of impairment of the battery due to dirt stirred up by the vehicle. Finally, due to the use of the fan, a homogeneous temperature distribution inside the battery is achieved. Local overheating of the cells can thus be virtually ruled out.

A “heat transfer medium” within the scope of the present invention may be understood to include any suitable liquid or gaseous cooling medium or heat transfer medium. These media and their properties and/or areas of use are essentially known from the state of the art and therefore will not be explained in greater detail here. Those skilled in the art can make a suitable selection here relatively easily.

A “motor vehicle” is understood within the scope of the present invention to refer to any motor-driven vehicle, i.e., land vehicles, including rail vehicles, watercraft and aircraft.

Although the invention has been explained on the basis of a battery for an electric vehicle in particular, the present invention of course also relates to batteries for other purposes, in particular including those for stationary installations and mobile devices. Advantageous embodiments and further refinements of the invention are derived from and/or disclosed by the remaining disclosure and description in conjunction with the drawings in the figures.

It is advantageous if the housing is hermetically sealed. In this way, dirt can be completely prevented from entering the interior of the housing. The battery thus remains usable for an especially long period of time. In addition, even if hazardous gases escape from the cell, they cannot reach the outside. This protects the environment and prevents any danger in enclosed spaces.

It is especially advantageous if the housing is filled with an insulating gas. Due to the insulating gas, cell fires in the interior of the battery cannot occur at all or are at least greatly suppressed. For example, nitrogen or sulfur hexafluoride (SF6) may be considered as an insulating gas.

It is advantageous if lithium-ion cells are provided as the galvanic cells. The lithium-ion battery is characterized by a high power density, is thermally stable and is not subject to a memory effect. Within the scope of the present invention, lithium-ion cells are also understood to include further developments such as lithium-polymer cells.

It is advantageous if cooling water is provided as the heat transfer medium. Although the suitability of water for heating and cooling purposes is well known, it has a special position in the field of battery construction. First, water is liquid in the target temperature range of most types of cells and therefore can remove a large amount of heat without allowing a dangerous excess pressure to build up in the lines due to vapor. Furthermore, water has good fire extinguishing properties and is not flammable in contrast with many other heat transfer media. Due to an unfortunate chain of defects in a battery during an accident, for example, due to a leak in the heat exchanger or in its forward or return flow, it could happen that the heat transfer medium flows into the interior of the battery during a fire in a cell. If the heat transfer medium is flammable or even explosive, this situation constitutes a substantial risk to life and limb. However, if water escapes, the fire is extinguished and cooled due to evaporation. The battery may optionally comprise an excess pressure valve through which the hazardous excess pressure is automatically released. The combination of an insulating gas in the interior of the housing and water as a heat transfer medium is particularly advantageous because then double safety is provided. Additives such as antifreeze may of course also be added to the cooling water.

It is also advantageous if web plates comprising or forming channels with the cells for the fluid flow are arranged between the galvanic cells. In this way, a certain distance and thus a certain fluid flow between the cells can be maintained. Batteries of motor vehicles in particular are exposed to very high accelerations, which, without further measures, can easily result in the cells being in contact with one another at least temporarily and thus escaping a targeted temperature regulation.

It is also advantageous if a plurality of galvanic cells is arranged between two web plates. In this way, it is possible to reduce the number of web plates and thus the volume not needed directly for power storage.

It is especially advantageous if the web plates are made of an elastic material, in particular an elastic plastic. Changes in volume in the cells with different charge states and/or temperatures can be compensated in this way.

Another essential point in the construction of batteries is the interconnection of individual cells because the required voltages (for example, 400 volt and higher) as well as the required energy capacity (for example, 100 Ah and above) cannot be achieved in any other way. Because of the high currents, a large line cross section is also required for connecting the cells.

To this end, a clamp is proposed for electrically connecting a plurality of galvanic cells of a battery, where the clamp comprises a generally U-shaped outer rail and an operating element, the operating element being connected to a clamp element in such a way that the clamp element is forced against at least one leg of the outer rail in operation of the operating element.

According to the invention, a clamp element operated via an operating element is arranged between the legs of the outer rail. On operation, the clamp element(s) is (are) pressed against the inside of the legs of the outer rail. If terminal lugs are then arranged between the legs and the clamp elements, cells can be connected by operating the operating element. First, the cells are connected securely because (conventional) manufacturing tolerances have only insignificant effects on the functioning of the clamp; second, the cells are connected flexibly because they may be connected to one another in any way (therefore, different types of batteries can be manufactured economically and inexpensively), and third, the cells are connected reversibly, so that repairs on the battery are facilitated. Furthermore, high currents can advantageously be passed over the U-shaped outer rail. Finally, a connection of cells arranged in a stack is thus possible in a comparatively simple manner.

It is advantageous if a cam positioned between the legs of the outer rail is provided as the clamp element and if a device for rotating the cam is provided as the operating element. In this variant of the invention, the clamp is operated by rotating the cam which is arranged in the U-shaped outer rail. For operation of the cam, it is merely necessary to rotate it about a comparatively small angle of rotation, so that the clamping operation and thus the production of a battery can proceed very rapidly.

It is also advantageous if an elastic body positioned between the legs of the outer rail is provided as the clamp element and if a screw and a screw element, which is furnished with a threaded hole and cooperates with the screw, are provided as the operating element, squeezing the elastic body when the screw is tightened. In this variant an elastic body inserted into the U-shaped outer rail is squeezed in height, so that it becomes wider and thereby clamps the cell terminal lugs, which are arranged between the outer rail and the elastic body. The elastic body is advantageously able to compensate well for manufacturing tolerances due to its elasticity. Conversely, this means that not very high demands need be made of the dimensional accuracy of the clamp without having to sacrifice a secure clamping effect. The clamp can thus be manufactured in a technically simple and therefore inexpensive manner. If recesses are provided in the cell terminal lug, then the elastic body will “creep” into it when clamped, so the clamp is practically prevented from pulling away due to the additional form-fitting connection.

It is also advantageous if a screw is provided as the operating element and if a screw element, which is furnished with a threaded hole and cooperates with the screw, is provided as the operating element, and if a body having a first interface is provided as the clamp element, such that this first interface cooperates with a second interface of the screw head, the screw element or an element situated between the screw head and the screw element, such that the clamp element is pressed against at least one leg of the outer rail when tightening the screw, at least one of the two interfaces being inclined with respect to the axis of the screw. This variant of the invention utilizes the wedge effect, for which there are several possibilities. For example, two wedge strips forming the clamp elements may be arranged in the U-shaped outer rail, so that they are forced apart and are thus pressed against the legs of the outer rail by an operating rail that forms the screw element. It is advantageous that in this variant, the clamping effect can be adjusted with a high precision through the choice of a suitable angle of the wedge elements. In addition, the clamping effect remains essentially constant over the entire operating time of the clamp because no elastic body, whose modulus of elasticity, dimensional stability, etc., optionally change over time, need be provided here.

An advantageous clamp also comprises clamp elements arranged on both sides of the screw and aligned along the outer rail. In this way, the same clamp elements may be used for outer rails of different widths. This greatly simplifies the storage of supplies for production and maintenance.

It is advantageous if the cross sections of the clamp elements are in mirror image with respect to the axis of the screw. In this way, the same basic material (raw material) may be used for both clamp elements. Storage for production and maintenance is thus especially simple.

It is also advantageous if the cross sections of the clamp elements are rotated by 180° with respect to one another about an axis aligned along the outer rail. This essentially results in the same advantages as those mentioned above for the variant described above.

An advantageous clamp comprises an elongated clamp element aligned along the outer rail and having a stationary central part and two clamp jaws connected thereto and facing the legs of the outer rail, such that the clamp jaws are bent apart when the screw is tightened and are pressed against the legs of the outer rail. This variant of the invention has the advantage that only one clamp element need be provided per clamp. Manufacturing the clamp is thus especially inexpensive because of the reduced number of individual parts and therefore the simplified manipulation.

It is especially advantageous if a U-shaped inner rail inserted into the outer rail is provided as the clamp element. The U-shaped profiles provided for both the outer rail and the inner rail are easy to manufacture and/or are ready-made products. The clamp can therefore be manufactured inexpensively. It is especially inexpensive if standard elements, for example, trapezoidal, triangular or cylindrical prisms and/or rods inserted into the inner rail are also used for the screw element.

It is advantageous if a plug or socket or clamp device is arranged in or on the outer rail. Not only should the clamp assume the role of connecting cells but frequently other units are also connected to it. For example, it is conceivable for the voltage of a clamp to be tapped for a control/monitoring circuit of the battery. This control/monitoring circuit may draw conclusions about the condition of the cell from the individual cell voltages. If the voltage of a cell drops significantly, an alarm message may be output, for example.

It is also advantageous if a temperature sensor is arranged in or on the outer rail. The cell temperature can be monitored relatively easily in this way because the heat migrates from the interior of the cell to the outer rail over the electrical conductors, which are usually also good heat conductors. Empirical experiments have shown which temperature on the outer rail corresponds to which cell (core) temperature. These data can be stored in a control/monitoring circuit of the battery and taken into account accordingly. It is thus unnecessary to furnish cells with temperature sensors and their wiring, which is complex and expensive. A plug, a socket or a clamp device may of course also be provided for the temperature sensor.

It is also advantageous if the clamp has a cooling rib and/or a vent hole. The terminal lugs of the cells are good current conductors and are thus also good heat conductors and therefore transport heat out of the interior of the cells or conduct heat to the cells. With the aid of the cooling ribs, this heat can be delivered to the fluid well or received from the fluid. The fluid can also pass through the clamp through the vent holes and thereby reach the cells. This provides effective means for regulating the temperature of the cells. Multiple cooling ribs and/or vent holes may of course also be provided to enhance this effect. Finally, providing a cooling rib and/or a vent hole may also form the basis for an independent invention independently of the other measures mentioned above.

Finally, it is advantageous if contacts of the galvanic cells are coated with a noble metal, in particular being silver-plated. In this way, an especially good electrical connection can be established between the contacts of a galvanic cell and a clamp.

The above embodiments and further refinements of the present invention can be combined in any desired way and manner.

The present invention is explained in greater detail below on the basis of the exemplary embodiments provided in the schematic drawings in the figures, in which:

FIG. 1 shows schematically a first variant of an inventive battery;

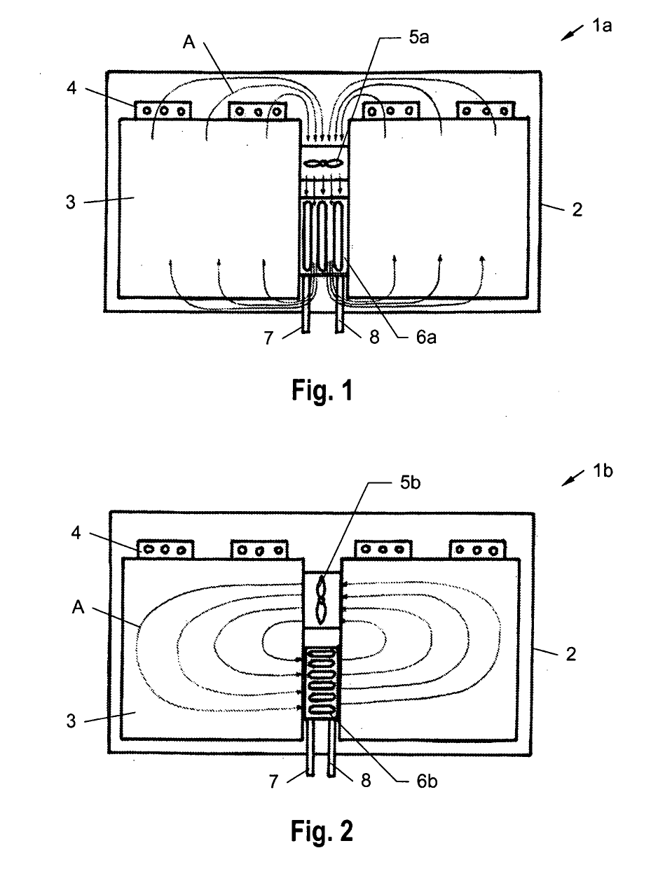

FIG. 2 shows schematically a second variant of an inventive battery;

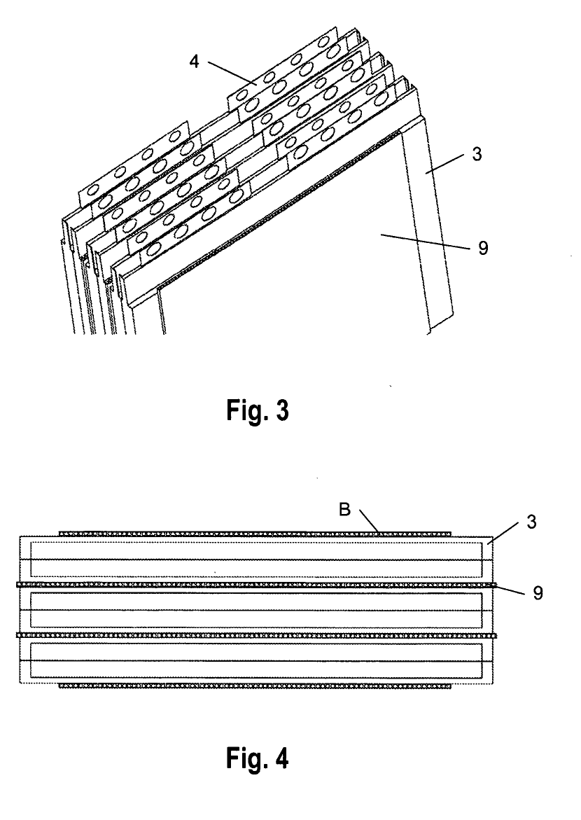

FIG. 3 shows a stack of cells in an inclined view;

FIG. 4 shows a stack of cells in a front view;

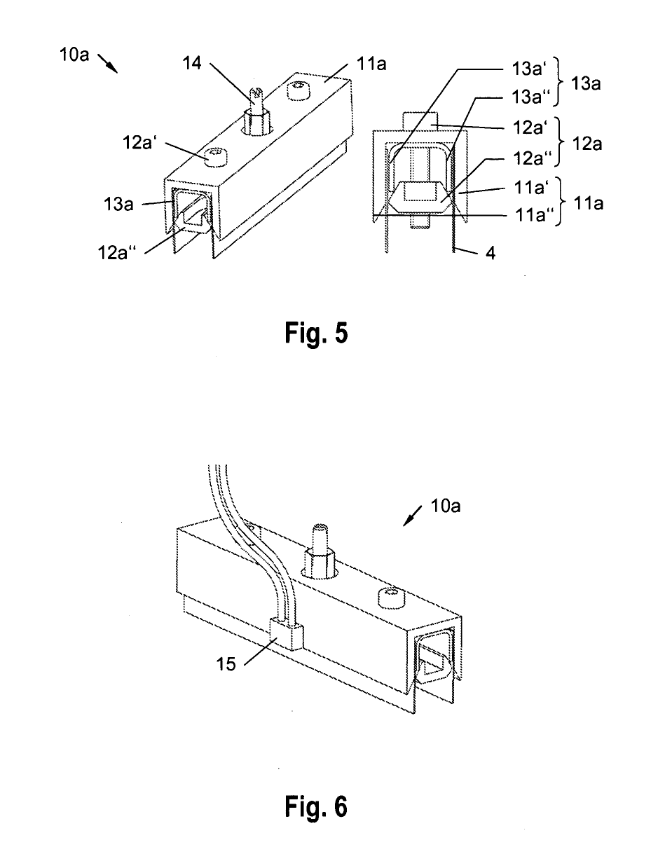

FIG. 5 shows a variant of an inventive clamp having a U-shaped inner rail;

FIG. 6 shows the backside of the clamp from FIG. 5 with a visible temperature sensor;

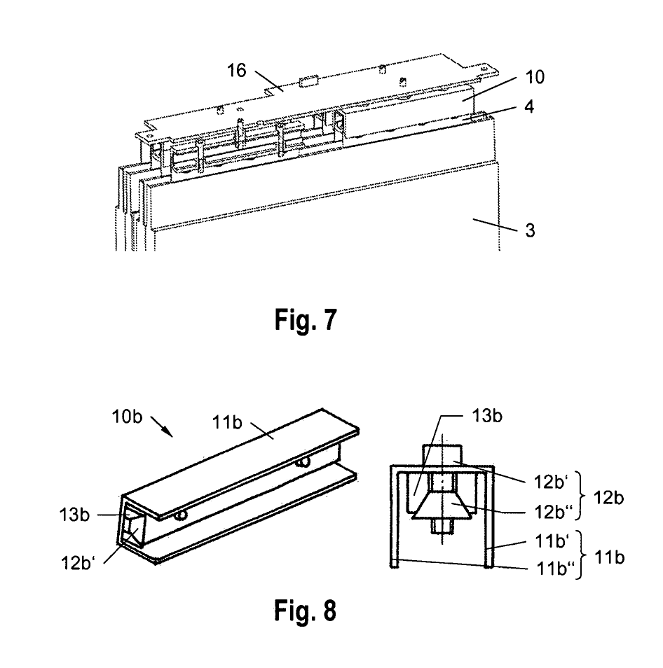

FIG. 7 shows a circuit board arranged over the clamps of a cell stack;

FIG. 8 shows a variant of an inventive clamp having two wedge strips;

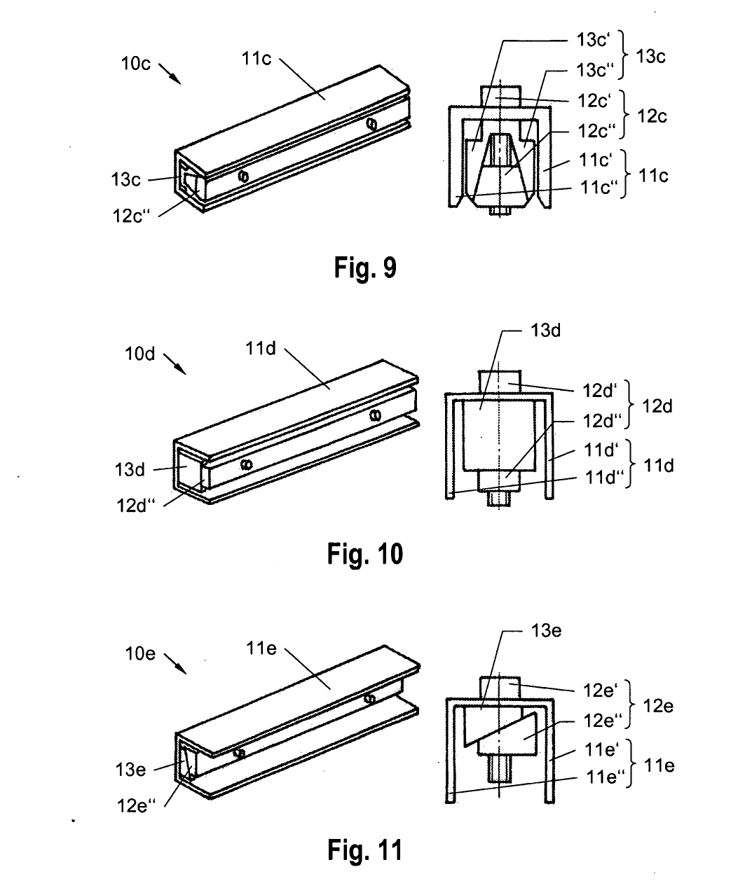

FIG. 9 shows a variant of an inventive clamp having a one-piece clamp element;

FIG. 10 shows a variant of an inventive clamp having an elastic clamp element;

FIG. 11 shows a variant of an inventive clamp having two wedged strips without a separate operating rail;

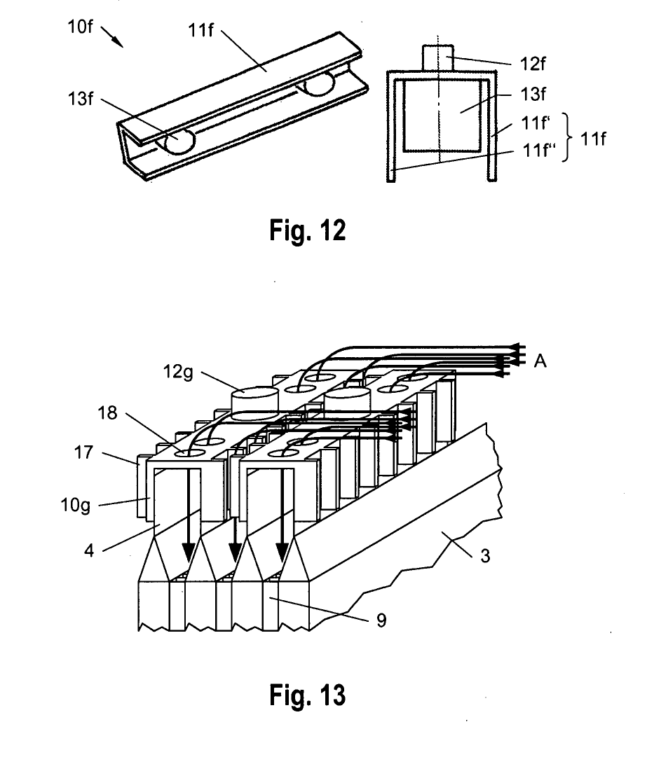

FIG. 12 shows a variant of an inventive clamp having eccentric clamp elements;

FIG. 13 shows a variant of an inventive clamp having cooling ribs and vent holes;

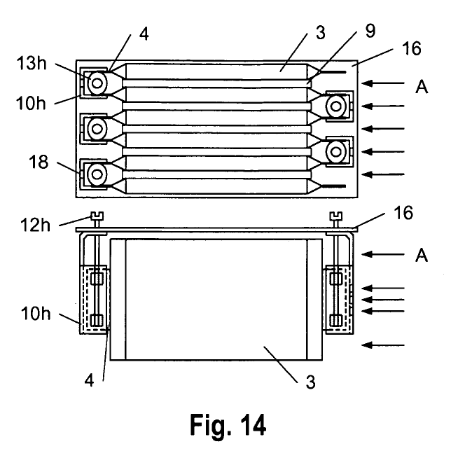

FIG. 14 shows a stack of cells having terminal lugs on both sides of the cell;

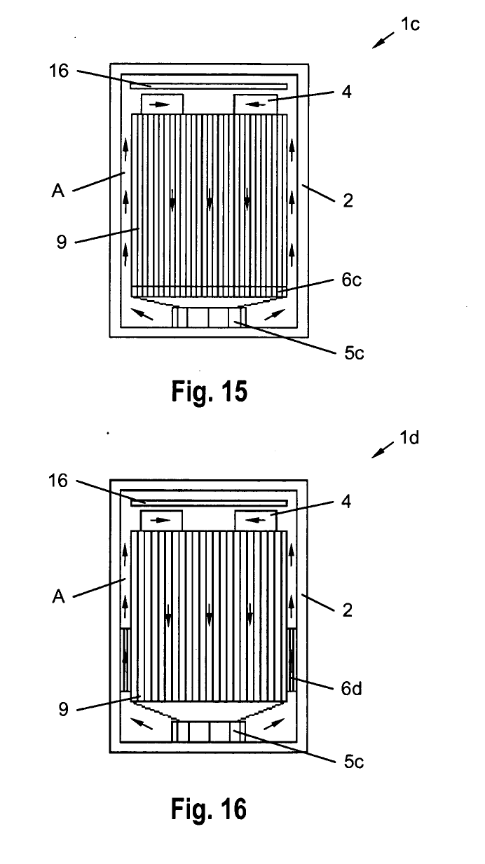

FIG. 15 shows a battery having a heat exchanger arranged beneath the cells and a radial fan arranged beneath the heat exchanger;

FIG. 16 shows a battery having a radial fan arranged beneath the cells and a heat exchanger arranged at the side next to the cells; and

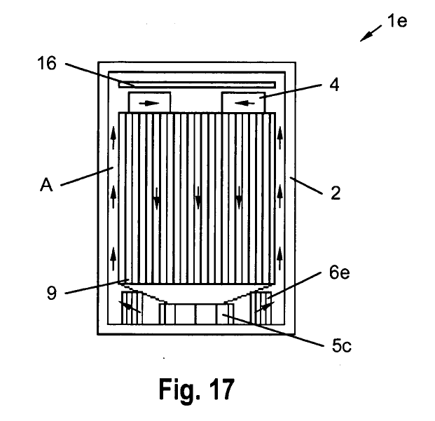

FIG. 17 shows a battery having a radial fan arranged beneath the cells and a heat exchanger arranged next to the radial fan.

The drawings in the figures show the same and similar parts labeled with the same reference numerals, where elements and features having similar functions are labeled with the same reference numerals but with different indices, unless otherwise indicated.

FIG. 1 shows a battery 1a comprising a housing 2, a plurality of galvanic cells 3 arranged in the housing 2 (for example, lithium-ion cells) having terminal lugs 4 and a fan 5a arranged in the housing 2 to produce a fluid flow within the housing 2. According to the invention, a heat exchanger 6a is arranged in the flow path A of the fluid flow. The heat exchanger 6a comprises a forward flow 7 and a return flow 8 for a heat transfer medium which lead out of the housing 2.

In the following examples, air is provided as the fluid. It would of course also be conceivable for the fluid to be a gas, for example, SF6, N₂ or CO₂. The aforementioned gases have fire-prevention properties, which is why a fire in cell 3 is suppressed or at least inhibited. In addition, the aforementioned gases prevent corrosion in the interior of the battery 1a.

The functioning of the arrangement illustrated in FIG. 1 will now be described as follows:

Interspaces through which air can pass are provided between the stacked cells 3 (the direction of stacking is perpendicular to the plane of the drawing in this example). With the aid of the fan 5a, an air stream is produced inside the housing 2. The heat exchanger 6a arranged in the flow path A of the air stream brings the air flowing through it to the desired temperature, thus heating or cooling the air. The air whose temperature is regulated in this way then also brings the cells 3 to the desired operating temperature. The heat transfer medium, e.g., water, flowing through the heat exchanger 6a, advantageously then carries heat to the battery 1a in an essentially known manner (the heat transfer medium is heated in a heating system, which is not shown here and is arranged outside of the housing 2) or it dissipates the heat (to this end, the heat transfer medium is cooled in another heat exchanger, which is also not shown here and is arranged outside of the housing 2).

In this way, the battery 1a can be brought uniformly to the desired operating temperature without requiring bulky cooling channels for supplying and removing cooling air. Instead of that, heat is supplied and removed through the comparatively small forward flow 7 and return flow 8. Another advantage is that the housing 2 is hermetically sealed and can be filled with an insulating gas, such as sulfur hexafluoride (SF6) or nitrogen instead of air, so there cannot be a fire due to an overheated cell 3.

FIG. 2 shows a battery 1b, which is very similar to the battery 1a shown in FIG. 1, but here the air supply, i.e., the flow path A of the air, is slightly different. Other variants of the air supply are also conceivable, for example, in meandering lines.

FIG. 3 shows a detail of a battery 1a, 1b namely from a stack having web plates 9 in between, the stack being formed from galvanic cells, shown here in an inclined view. This shows clearly that two cells 3 are arranged between two web plates. The contacts of the galvanic cells 3, which are designed here as terminal lugs 4, may also be coated with a noble metal, in particular being silver-plated, in a preferred variant.

FIG. 4 shows the arrangement from FIG. 3 in a side view. This shows readily that flow channels B for the air flow are arranged in the web plates 9. Alternatively, the channels may also be formed by the web plate 9 and the cells 3. The border of the web plates 9 facing the cells 3 may thus be eliminated. In a preferred embodiment, the web plates 9 are made of an elastic material, for example, an elastic plastic, so that the change in volume of the cells 3 in different charge states and/or temperatures can be compensated.

FIG. 5 then shows an advantageous possibility for connecting the cells 3. To do so, a clamp 10a (shown here in a front view and a side view) is used, comprising a U-shaped outer rail 11a and an operating element 12a as well as a clamp element 13a. The operating element 12a is coupled to the clamp element 13a in such a way that the clamp element 13a is pressed against at least one leg 11a′, 11a″ of the outer rail 11a, when the operating element 12a is operated.

In the concrete example, a plurality of screws 12a′ is provided as the operating element 12a, and an operating rail 12a″ that is provided with matching inside threads and cooperates with screws 12a′, is provided as the screw element. A U-shaped inner rail, which is inserted into the outer rail 11a, is provided as the clamp element 13a. The clamp element 13a thus has a stationary central part and two clamp jaws 13a′, 13a″, which are connected to the central part and face the legs of the outer rail, so that when the screw 12a′ is tightened, the clamp jaws are bent apart and pressed against the legs of the outer rail. The clamp elements 13a′, 13a″ are also arranged on both sides of the screw 12a′ and are aligned along the outer rail 11a. In addition, the cross section of the clamp element 13a is designed in mirror image with respect to the axis of the screw.

FIG. 5 also shows clearly that the U-shaped inner rail 13a has a first interface cooperating with a second interface of the operating rail 12a″ (screw element) in such a way that the clamp jaws 13a′, 13a″ of the U-shaped inner rail 13a are pressed against the legs 11a′, 11a″ of the outer rail 11a when the screws 12a′ are tightened. The second interfaces of the operating rail 12a″ which cooperate with the clamp jaws 13a′, 13a″ are inclined with respect to the axes of the screws 12a′.

The terminal lugs 4 of the cells 3 (the cells 3 are not shown in FIG. 5) are arranged between the legs 11a′ and 11a″ of the outer rail 11a and the clamp jaws 13a′ and 13a″, so that the cells 3 and/or their terminal lugs 4 are connected to one another when the screws 12a′ are tightened.

An auxiliary clamp 14 for connecting a cable to the clamp 10a is provided on the outer rail 11a of the clamp 10a. For example, the cell voltage for a voltage monitoring circuit can be tapped here.

FIG. 6 shows the rear side of the clamp 10a shown in FIG. 5. As this shows, a temperature sensor 15 is arranged in or on the outer rail 11a. It is also conceivable for a plug or socket to be provided for this purpose.

FIG. 7 shows a composite of a plurality of cells 3, whose terminal lugs 4 are connected to clamps 10 to produce a serial or parallel circuit of the cells 3, for example. A circuit board 16 on which an electronic circuit (not shown) for controlling and/or monitoring the battery 1 is arranged above the clamps 10. The clamps 10 in this example comprise auxiliary clamps 14 (see also FIG. 5) which protrude through the circuit board 16. It is very easy in this way for clamps 10 to come in contact with the circuit board 16 and thus with the circuit arranged thereon.

FIGS. 8 through 12 show additional variants of clamps 10b . . . 10f, each shown in a front view and in an oblique view.

FIG. 8 shows a clamp 10b, comprising a U-shaped outer rail 11b, an operating element 12b and a clamp element 13b.

In the concrete example, several screws 12b′ are provided as operating element 12b, and an operating rail 12b″, which is provided with corresponding threaded holes and cooperates with the screws 12b′, is provided as the screw element. Two wedge strips inserted into the outer rail 11b are provided as the clamp element 13b.

The clamp elements 13b are elongated, are arranged on both sides of the screws 12b′ and are aligned along the outer rail 11b. The cross sections of the clamp elements 13b are in mirror image with respect to the screw axis. FIG. 8 also shows clearly how the interfaces of the clamp elements 13b and of the operating rail 12b″, which are inclined with respect to the screw axis, can also be seen well there. In tightening the screws 12b′, the operating rail 12b″ is pulled upward and thereby presses the clamp elements 13b against the legs 11b′, 11b″ of the outer rail 11b.

The terminal lugs 4 of the cells 3 (terminal lugs 4 and cells not shown in FIG. 8) are arranged between the legs 11b′ and 11b″ of the outer rail 11b and the clamp jaws 13b′ and 13b″, so that the cells 3 and/or their terminal lugs 4 are connected to one another when the screws 12b′ are tightened.

FIG. 9 shows a variant of a clamp 10c, which is very similar in function to the clamp 10a shown in FIG. 5. Instead of the U-shaped inner rail 13a, however, a specially shaped inner rail 13c is provided here, this embodiment being characterized essentially in that the central part and the clamps jaws 13c′ and 13c″ are designed to be comparatively thick and are connected to one another via a comparatively narrow web. In addition, the clamp jaws 13c′ and 13c″ have an interface, which is inclined with respect to the screw axis and which cooperates with an interface of the operating rail 12c″.

FIG. 10 shows a clamp 10d, in which an elastic body arranged between the legs 11d′ and 11d″ of the outer rail 11d is provided as the clamp element 13d, and a screw 12d′ and a screw element 12d″, which is furnished with a threaded hole and cooperates with the screw 12d′, are provided as the operating element 12d. The screw element 12d″ is designed as a flat strip having a plurality of threaded holes.

In tightening the screws 12d′ the flat strip 12d″ is pulled upward and thereby deforms the elastic body 13d, the height of which then decreases but the width of which increases.

The terminal lugs 4 of the cells 3 (terminal lugs 4 and cells 3 not shown in FIG. 10) are arranged between the legs 11d′ and 11d″ of the outer rail 11d and the elastic body 13d, so that the cells 3 and/or their terminal lugs 4 are connected to one another in tightening the screws 12d′. When holes are arranged in the terminal lugs 4 as shown in FIG. 3, the elastic body 13d then creeps into these holes when the screws 12d′ are tightened, thus creating an additional form-fitting connection.

FIG. 11 shows a clamp 10e, in which several screws 12e′ are provided as the operating element 12e, and an operating rail 12e″ that is provided with corresponding threaded holes and cooperates with the screws 12e′ is provided as the screw element. In addition, in this concrete example, the operating rail 12e″ also assumes the function of a clamp element (therefore, this is sometimes also referred to as clamp element 12e″ below). A wedge strip inserted into the outer rail 11e is also provided as an additional clamp element 13e. In this example, the cross sections of the clamp elements 12e″, 13e are rotated 180° with respect to one another about an axis aligned along the outer rail 11e.

FIG. 11 also shows quite well the interaction of the interfaces of the clamp elements 12e″ and 13e, which are inclined with respect to the screw axis. When the screws 12e′ are tightened, the clamp element 12e″ is pulled upward and in doing so interacts with the clamp element 13e, so that both are pressed against the legs 11e′, 11e″ of the outer rail 11e. Therefore, elongated holes for the screws 12e′ are provided in the outer rail 11e and also in the clamp element 13e.

In an alternative embodiment, the clamp element 12e″ does not include any threaded holes or any elongated holes. In addition, a flat strip is then provided as the operating rail (as in FIG. 10), pressing on both wedge-strip-shaped clamp elements 13. In this case, no elongated hole needs to be provided for the screws 12e′ in the outer rail 11e.

In both cases the terminal lugs 4 of the cells 3 (terminal lugs 4 and cells not shown in FIG. 11) are arranged between the legs 11e′ and 11e″ of the outer rail 11e and the clamp jaws 13e′ and 13e″ so that the cells 3 and/or their terminal lugs 4 are joined together when tightening the screws 12e′.

FIG. 12 shows a clamp 10f, where a cam arranged between the legs 11f′ and 11f″ of the outer rail 11f is provided as the clamp element 13f, and a device for turning the cam 13f is provided as the operating element 12f. In the example shown here, a screw-head-shaped protrusion of the clamp element 13f is provided as the operating element 12f. For example, a screw may be screwed into the cam 13f and then welded to it or a permanent connection may be established with the aid of an adhesive.

If the cam 13f is then rotated, its lateral surface is pressed against the legs 11f, 11f″ of the outer rail 11f.

The terminal lugs 4 of the cells 3 (terminal lugs 4 and cells 3 not shown in FIG. 12) are again arranged between the cam 13f and the legs 11f′ and 11f″ of the outer rail 11f, so that the cells 3 and/or their terminal lugs 4 are connected to one another in operation of the cam 13f.

The axle of the cam 13f may also run parallel to the outer rail 11f, so that the cam 13f can be operated by means of an axle leading out at the side and/or an operating element 12f leading out at the side on the end face of the rail 11f. For example, a plurality of cams 13f may thus be operated simultaneously with one operating element 12f. The operating element 12f leading out at the side may be advantageous if the outside surfaces of the rail 11f are not accessible or are covered, e.g., by a circuit board 16, as shown in FIG. 7.

Clamp elements 13b . . . 13e and prism-shaped operating rails 12b . . . 12e extending over the entire length of outer rail 11b . . . 11e are always provided with the clamps 10b . . . 10e shown in FIGS. 8 through 11. This is advantageous because rod stock that can be cut to any length may be used for this purpose, but this is by no means necessary. It is therefore also possible for the aforementioned elements to extend over only a portion of the outer rail 12b . . . 12e. A plurality of such elements may also be provided. In addition, the aforementioned elements are also not necessarily prismatic. It is also conceivable for it to be rotationally symmetrical about the axis of the respective assigned screw 12b′ . . . 12e′. For example, instead of the operating rail 12b . . . 12e, a plurality of nuts in the form of truncated cones may also be provided in FIG. 8. In another alternative embodiment, instead of an individual prismatic elastic body 13d shown in FIG. 10, several elastic bodies in the shape of cylinders may also be provided.

In addition, instead of the threaded holes, through-holes may also be provided in the operating rail 12b . . . 12e. Then the operation is accomplished via (traditional) nuts.

In addition, the shape of the screw 12b′ . . . 12e′ can be seen only as an example. Other shapes may of course also be used. The position of the screw head may also be exchanged with the position of a nut, so that the outer rail 11b . . . 11e passes through the screw 12b′ . . . 12e′ from beneath. A countersunk screw may also be provided with the clamps 10a from FIG. 5, clamps 10b from FIG. 8 and clamps 10c from FIG. 9. The clamping effect may then be accomplished by the shape of the screw head in the form of a truncated cone. Finally, a threaded pin having a nut may also be provided instead of a screw 12b′ . . . 12e′.

In particular for the clamps 10a from FIG. 5, 10b from FIGS. 8 and 10c from FIG. 9, it is also conceivable for the operating rail 12a″, 12b″ and 12c″ to be formed by a cylindrical prism, whose longitudinal axis is aligned along the outer rail 11a, 11b and/or 11c. Due to the mere linear contact with the clamp elements 13a, 13b and 13c, the clamps 10a, 10b and 10c may under some circumstances be operated by applying less force.

This is the case in particular when the diameter of the cylindrical operating rail 12a″ in the case of the clamp 10a from FIG. 5 is selected so that the effective angle between the inside rail 13a and the operating rail 12a″ is relatively shallow in the end position. Thus the legs 11a′ and 11a″ are initially pressed apart relatively rapidly due to the progressively smaller active clamp angle because of the cylindrical shape, but the movement of the legs 11a′ and 11a″ is repeatedly retarded in favor of an increased wedge effect and thus a reduced expenditure of force. This variant of the clamp 10a is therefore especially convenient to operate because it permits relatively rapid clamping, but on the other hand it also allows relatively high clamping forces.

FIG. 13 shows a detail from another battery, namely a stack formed from galvanic cells 3 with web plates 9 in between shown in an inclined view. The terminal lugs 4 are combined with clamps 10g, which are operated via the operating element 12g and have additional cooling ribs 17 and vent holes 18. The terminal lugs 4 are good current conductors and also good heat conductors and thus dissipate heat from or carry it to the interior of the cells 3. With the aid of the cooling ribs 17, this heat can be dissipated well to or absorbed from the circulated air. Moreover, air can pass through the vent holes 18 through the clamp 10g and can thereby reach the web plates 9 and/or cells 3 (marked by arrows for flow path A). The temperature of the cells 3 is thus effectively regulated. The aforementioned measures, i.e., the cooling ribs 17 and the vent holes 18, of course need not be used jointly but instead may also be provided individually. The cooling ribs 17 and/or the vent holes 18 may of course be provided on all the models of clamps and are also suitable in principle for other clamps 10a . . . 10f besides those shown in FIGS. 5 to 12. Thus the cooling ribs 17 and/or the vent holes 18 may in general form the basis for an independent invention for clamps for electrically connecting a plurality of galvanic cells of a battery.

FIG. 14 shows a detail from another battery, namely a stack formed from galvanic cells 3 with rib plates 9 situated in between in a top view and a front view. As this readily shows, the clamps 10h for connecting the terminal lugs 4 are not situated only on one side of the stack but instead are on both sides. In this way, cells 3 which have terminal lugs 4 can be connected on several sides. A circuit board 16 is arranged above the cell stack (shown here transparently and without electronic components). For example, the circuit board 16 may have a circuit for monitoring the battery. The clamps 10h are mounted on the bottom side of the circuit board 16 by means of straps. Two clamp elements 13h (cams here), whose axis is oriented along a clamp 10h, are each operated via an operating element 12h and thus clamp the terminal lugs 4. In the clamps 10h, vent holes 18 are again provided in the flow path A to allow the passage of air.

FIG. 15 shows another variant of an inventive battery 1c, where again a plurality of cells (of which only terminal lugs 4 are visible in FIG. 15) with web plates 9 in between are arranged in a housing 2. A heat exchanger 6c and a fan 5c, which in this case is designed as a radial fan, are arranged beneath the stack formed of the cells on the web plates 9. The circuit board 16 is arranged above the aforementioned stack for connecting the terminal lugs 4. The fan 5c produces an air stream (visualized with arrows) along the flow path A circulating inside the housing 2. The air stream is guided upward along the outside of the cell stack and from there over the web plates 9 to the heat exchanger 6c. The forward flow and return flow of the heat exchanger 6c, which lead out of the housing 2, are not shown in FIG. 15 for the sake of simplicity.

FIG. 16 shows another variant of an inventive battery 1d, which is very similar to the battery 1c shown in FIG. 15. In contrast with that, however, the heat exchanger 6d is not arranged beneath the cell stack but instead is at the side.

Finally, FIG. 17 shows yet another variant of an inventive battery 1e, which is also very similar to the battery 1c shown in FIG. 15. Although the heat exchanger 6d is again arranged beneath the cell stack, in this case it is not situated above the fan 5c but rather to the side of it.

In conclusion, it is pointed out that the variants presented here are only a selection of the many possibilities for an inventive battery 1a . . . 1e and must not be used to limit the scope of the present invention. For the person skilled in the art, it should be easy to adapt the invention to his own needs based on the considerations presented here without going beyond the scope of the invention. In addition, it is pointed out that parts of the devices presented in the figures may also form the basis for independent inventions.

### List of Reference Labels

A flow path
B flow channel
1a . . . 1e battery
2 housing
3 galvanic cell
4 terminal lug
5a . . . 5c fan
6a . . . 6e heat exchanger
7 forward flow
8 return flow
9 web plate
10a . . . 10h clamp
11a . . . 11f outer rail
12a . . . 12g operating element
12a′ . . . 12e′ screw
12a″ . . . 12e″ operating rail
13a . . . 13f, 13h clamp element
13a′, 13a″ clamp jaws
13c′, 13c″ clamp jaws
14 auxiliary clamp
15 temperature sensor
16 circuit board
17 cooling rib
18 vent hole

What is claimed is:

1-59. (canceled)

60. A battery system comprising:
a hermetically sealed housing containing insulating fluid;
a stack of galvanic cells arranged in said housing, said stack of galvanic cells including a plurality of galvanic cells;
a plurality of web plates interposed in said stack of galvanic cells, each of said web plates being disposed, respectively, between a respective pair of adjacent galvanic cells;
each of said plurality of web plates forming a respective plurality of flow channels for conducting the insulating fluid;
a heat exchanger configured to either add or remove heat to the insulating fluid, said heat exchanger disposed in said housing, said heat exchanger conducting a heat transfer medium therethrough;
a forward flow conduit passing through said hermetically sealed housing and connecting to said heat exchanger for introducing heat transfer medium therethrough;
a return flow conduit passing through said hermetically sealed housing and connecting to said heat exchanger for withdrawing heat transfer medium therefrom; and,
a fan for circulating the insulating fluid, said fan circulating the insulating fluid over an exterior surface of said heat exchanger, said fan circulating the insulating fluid through said flow channels of said web plates.

61. The battery system as claimed in claim 60, wherein,
at least one of said plurality of web plates has its respective plurality of flow channels formed internally.

62. The battery system as claimed in claim 60, wherein,
at least one of said plurality of web plates has its respective plurality of flow channels defined in cooperation with at least one adjacent galvanic cell.

63. The battery system as claimed in claim 60, wherein,
said web plates are made of an elastic material.

64. A battery system as claimed in claim 60, further comprising, a clamp electrically connecting at least two of said plurality of galvanic cells.

65. A battery system as claimed in claim 64, further comprising, said clamp has at least one cooling rib.

66. A battery system as claimed in claim 65, further comprising, said clamp has at least one vent hole configured to pass the insulating gas.

67. The battery system as claimed in claim 60, further comprising,
said plurality of galvanic cells includes at least one galvanic cell contact; and,
said contact is coated with a noble metal.

68. A battery system comprising:
a hermetically sealed housing containing insulating fluid;
a stack of galvanic cells arranged in said housing, said stack of galvanic cells including a plurality of galvanic cells;
a plurality of web plates interposed in said stack of galvanic cells, at least one of said web plates being disposed, respectively, between a respective pair of adjacent galvanic cells;
each of said plurality of web plates forming a respective plurality of flow channels for conducting the insulating fluid;
a heat exchanger configured to either add or remove heat to the insulating fluid, said heat exchanger disposed in said housing, said heat exchanger conducting a heat transfer medium therethrough;
a forward flow conduit passing through said hermetically sealed housing and connecting to said heat exchanger for introducing heat transfer medium therethrough;
a return flow conduit passing through said hermetically sealed housing and connecting to said heat exchanger for withdrawing heat transfer medium therefrom; and,
a fan for circulating the insulating fluid, said fan circulating the insulating fluid over an exterior surface of said heat exchanger, said fan circulating the insulating fluid through said flow channels of said web plates.

69. The battery system as claimed in claim 68, wherein,
at least one of said plurality of web plates has its respective plurality of flow channels formed internally.

70. The battery system as claimed in claim 68, wherein,
at least one of said plurality of web plates has its respective plurality of flow channels defined in cooperation with at least one adjacent galvanic cell.

71. The battery system as claimed in claim 68, wherein,
said web plates are made of an elastic material.

72. A battery system as claimed in claim 68, further comprising,
a clamp electrically connecting at least two of said plurality of galvanic cells.

73. A battery system as claimed in claim 72, further comprising,
said clamp has at least one cooling rib.

74. A battery system as claimed in claim 72, further comprising,
said clamp has at least one vent hole configured to pass the insulating gas.

75. The battery system as claimed in claim 68, wherein,
said plurality of galvanic cells includes at least one galvanic cell contact; and,
said contact is coated with a noble metal.

76. A battery stack assembly comprising:
a first lithium-ion cell plate;
a second lithium-ion cell plate proximate to said first lithium-ion cell plate;
a web plate disposed between said first and second lithium-ion cell plates, said web plate forming a plurality of flow channels;
a plurality of terminal lugs on said first and second lithium-ion cell plates;
a clamp electrically connecting at least two of said terminal lugs; and,
at least one cooling rib or at least one vent hole.

77. The battery system as claimed in claim 76, wherein,
said web plate has its plurality of flow channels defined in cooperation with at least one adjacent galvanic cell.

78. The battery system as claimed in claim 77, wherein,
said galvanic cell includes at least one galvanic cell contact; and,
said contact is coated with a noble metal.

79. The battery system as claimed in claim 76, wherein,
said web plate has its plurality of flow channels formed internally.

80. The battery system as claimed in claim 76, wherein,
said web plate is made of an elastic material.
